(19) United States
(12) Patent Application Publication
(10) Pub. No.: US 2006/0203295 A1
(43) Pub. Date: Sep. 14, 2006

(54) Device, system and method for monitoring and interacting with a primary user

(76) Inventors: William T. D'Silva, Unionville (CA); Alan D'Silva, Unionville (CA)

Correspondence Address: GEORGE A. ROLSTON, 45 SHEPPARD AVE EAST, SUITE 900, TORONTO, ON, M2N5W9, CA

(21) Appl. No.: 11/372,125

(22) Filed: Mar. 10, 2006

Related U.S. Application Data
(60) Provisional application No. 60/659,868, filed on Mar. 10, 2005.

(51) Int. Cl. H04N 1/00

(52) U.S. Cl. 358/403

(57) ABSTRACT

A personal management system for monitoring and interacting with a primary user located within a residence including one or more source modules provided throughout the residence, the one or more source modules being adapted to gather one or more source inputs concerning the conditions within the residence, one or more input modules provided to the primary user and throughout the residence, the one or more input modules being adapted to receive one or more user inputs from the primary user, wherein the one or more user inputs are requests for one or more outputs received from the primary user, a central processing module communicating with the one or more source modules and the one or more inputs modules, wherein the central processing module is programmed to analyze the one or more source inputs and the one or more user inputs, and wherein the central processing module is further programmed to dynamically generate one or more outputs based on the conditions within the residence and the requests from the primary user, and one or more output modules provided throughout the residence and being adapted to perform and communicate the one or more outputs for the primary user. A method for providing personal management monitoring and interaction with a primary user located within a residence including the steps of receiving one or more source inputs concerning the conditions within the residence, receiving one or more user inputs from the primary user, analyzing and interpreting the one or more source inputs and the one or more user inputs, retrieving one or more historical outputs from a database that were previously communicated to the primary user generally concerning the one or more source inputs and the one or more user inputs, and dynamically generating one or more outputs concerning the one or more source inputs and the one or more user inputs.

### PRIOR APPLICATION

This application claims the benefit of U.S. Provisional Application Ser. No. 60/659,868, filed Mar. 10, 2005, entitled DYNAMIC, INTELLIGENT, MULTILINGUAL ELECTRONIC COMPANION AND MENTOR.

### FIELD OF THE INVENTION

The present invention relates to the field of personal management and monitoring devices, systems and methods, and is more specifically directed to a personal care device, system and method for monitoring and interacting with a primary user.

### BACKGROUND OF THE INVENTION

In modern home and business environments, the need for technologies designed to manage and coordinate an individual's daily tasks and activities is vital. This is especially important in households where both parents are employed full-time and must manage family obligations, such as chores and childcare, along with employment responsibilities and duties. Many of the technologies that have been designed to ease the burdens associated with busy lifestyles have had the effect of isolating and marginalizing individuals from their extended family members, and particularly dependent elderly and physically challenged family members. As a result, direct communications between family members via in-person meetings and telephone are increasingly being replaced by indirect communications via the Internet, fax and email, for example. Since many elderly and physically challenged individuals may not have access to the Internet, a fax machine or a computer, or may lack the technical skills required for operating these devices, they are often unable to communicate with their family members on a regular basis. Moreover, the isolation experienced by dependent individuals is often greater when the individual resides a considerable distance from their family members. Family members are often unable to commute to the dependent individual's residence on a regular basis to provide medical assistance, supervision or companionship. The time available for family members to care for an elderly or physically challenged individual is limited by the needs and obligations of their direct family members, such as children, and employment obligations.

The increased availability of third party personal care facilities, such as retirement and assisted living residences, has permitted many elderly and physically challenged individuals to receive continual medical assistance, supervision and companionship while maintaining a substantially independent lifestyle. Unfortunately, the cost associated with lodging a dependent individual at a person care facility is prohibitive for most family members. In addition to the costs associated with such facilities, many elderly and physically challenged individuals prefer the privacy and independence of living alone or with their significant other in a proper residence. To a limited extent, sophisticated home monitoring systems can provide dependent individuals with a degree of security in the event of an emergency situation, such as a fire or break-in attempt. These monitoring systems are typically designed to react to specific emergency situations and do little to ease the dependent individual's sense of isolation from family members and the surrounding community.

Accordingly, there is a need for a personal management device, system and method for monitoring and interacting with a dependent individual using a portable computerized device. Furthermore, there is a need for a portable computerized device that will enable a dependent individual to easily communicate and interact with their family members. Furthermore, there is a need for a personal management device, system and method for facilitating the remote monitoring and interaction with a dependent individual by a secondary user, such as family members, acquaintances, health care personnel and other interested parties.

### SUMMARY OF THE INVENTION

The present invention is directed to a personal management system for monitoring and interacting with a primary user located within a residence including one or more source modules provided throughout the residence, the one or more source modules being adapted to gather one or more source inputs concerning the conditions within the residence, one or more input modules provided to the primary user and throughout the residence, the one or more input modules being adapted to receive one or more user inputs from the primary user, wherein the one or more user inputs are requests for one or more outputs received from the primary user, a central processing module communicating with the one or more source modules and the one or more inputs modules, wherein the central processing module is programmed to analyze the one or more source inputs and the one or more user inputs, and wherein the central processing module is further programmed to dynamically generate one or more outputs based on the conditions within the residence and the requests from the primary user, and one or more output modules provided throughout the residence and being adapted to perform and communicate the one or more outputs for the primary user. The central processing module being adapted to communicate the one or more source inputs to a secondary user situated at a remote location. The central processing module being adapted to communicate the one or more user inputs to a secondary user situated at a remote location. The central processing module being adapted to communicate the one or more outputs to a secondary use situated at a remote location. The personal management system further including one or more cognitive databases, each of the one or more cognitive databases being adapted to store and load the one or more source inputs, the one or more user inputs and the one or more outputs. The central processing module being adapted to retrieve one or more historical outputs from a database that were previously generated by the system concerning the one or more source inputs and the one or more user inputs, and wherein the central processing module being adapted to dynamically generate one or more outputs in response to the one or more source inputs and the one or more user inputs based on the one or more historical outputs. The central processing module further including a speech generator for interactively communicating with the primary user, and wherein the speech generator being adapted to communicate the one or more outputs to the primary user in the form of synthesized speech. The central processing further including an inference engine adapted to analyze and interpret the one or more outputs based on the contextual patterns contained in the one or more source inputs and the one or more user inputs. The one or more output modules provided throughout the residence include addressable speakers and being adapted to perform and communicate the one or more outputs for the primary user. The one or more source inputs contain information concerning the condition of the primary user and the residence.

The present invention is further directed to a method for providing personal management monitoring and interaction with a primary user located within a residence, the steps of the method including receiving one or more source inputs concerning the conditions within the residence, receiving one or more user inputs from the primary user, analyzing and interpreting the one or more source inputs and the one or more user inputs, retrieving one or more historical outputs from a database that were previously communicated to the primary user generally concerning the one or more source inputs and the one or more user inputs, and dynamically generating one or more outputs concerning the one or more source inputs and the one or more user inputs. Method for providing personal management monitoring and interaction further including the additional step of performing and communicating the one or more outputs for the primary user. The method of providing personal management monitoring and interaction wherein the one or more user inputs are requests for one or more outputs received from the primary user. The method for providing personal management monitoring and interaction wherein the steps of the method are performed iteratively.

The method for providing personal management monitoring and interaction further including the additional step of generating one or more outputs for the primary user based upon the occurrence of one or more scheduled triggering events. The method wherein the one or more user inputs and the one or more outputs are verbally communicated and inputted by the primary user. The method for providing personal management monitoring and interaction wherein the one or more outputs perform functions within the residence for the primary user. The method of the present invention wherein the one or more outputs are communicated to one or more secondary users, wherein the one or more outputs providing the one or more secondary users with information concerning the condition of the primary user and the residence.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic diagram illustrating an embodiment of a personal management system for monitoring and interacting with a primary user designed in accordance with a preferred embodiment of the present invention;

FIG. 2 is a schematic diagram illustrating an embodiment of the personal management system for monitoring and interacting with a primary user designed in accordance with an embodiment of the present invention;

FIG. 3 is a schematic diagram illustrating an embodiment of the central processing module of the personal management system of FIG. 1;

FIG. 4 is an exemplary diagram of a residence utilizing the personal management system of FIG. 1;

FIG. 5 is a flowchart showing the steps performed in a method of monitoring and interacting with a primary user in accordance with a preferred embodiment of the present invention;

FIG. 6 is a flowchart showing the steps performed in generating one or more outputs based on one or more source inputs;

FIG. 7 is a flowchart showing the steps performed in generating one or more outputs based on one or more user inputs;

FIG. 8 is a flowchart showing the steps performed in generating one or more outputs based scheduled triggering events;

FIG. 9 is a perspective view of a fob module made in accordance with an embodiment of the present invention;

FIG. 10 is a perspective view of a fob module made in accordance with an embodiment of the present invention; and

FIG. 11 is a perspective view of a fob module made in accordance with an embodiment of the present invention.

### DETAILED DESCRIPTION OF THE INVENTION

In accordance with the present invention, a device, system, and method for monitoring and interacting with a primary user using a portable computerized device, one or more input modules and one or more output modules. The present invention is designed to interact with the primary user to provide personal management and management assistance by receiving one or more user inputs from the primary user, such as requests or information, and recording and fulfilling such one or more inputs for the primary user. The present invention is further adapted to enable one or more secondary users, such as family members, health care personnel, business advisors, spiritual advisors and other interested parties, to communicate with the primary user from a remote location.

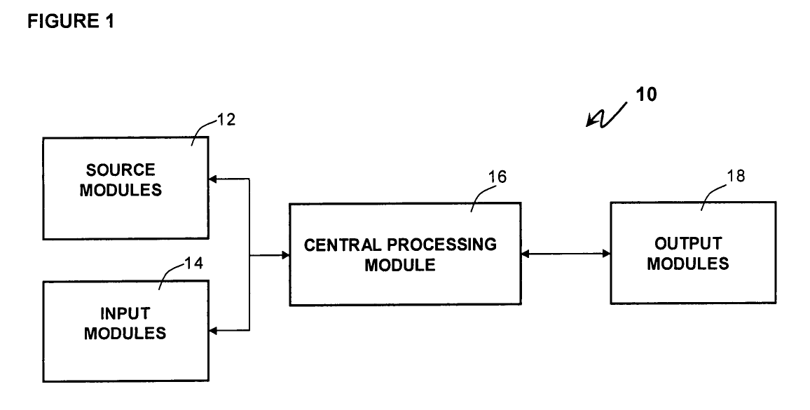

In a preferred embodiment of the present invention, personal management system 10 is a computer application that comprises a set of integrated components in a modular form that are adapted to monitor and interact with the primary user. The set of integrated components in a modular form may be software, hardware or any combination thereof. The primary user may be any suitable individual desirous of receiving assistance with the monitoring and managing of their daily activities and personal care. Possible primary users of the system may include elderly and physically challenged individuals, and children. However, it should be understood that the primary user may also be a business professional, for example, who is desirous of obtaining assistance with the management of their professional and personal activities and obligations. Referring to FIG. 1, the personal management system 10 comprises of one or more source modules 12, one or more input modules 14, a central processing module 16, and one or more source output modules 18. The one or more source modules 12 are programmed to receive a plurality of inputs from the conditions within and surrounding the primary user's residence or office. The input modules 14 are adapted to receive one or more user inputs directly from the primary user. The one or more source inputs and the one or more user inputs are collectively referred to herein as “the inputs”. The central processing module 16 is adapted to receive and process the inputs from the source modules 12 and/or the input modules 14, and, if necessary, provide one or more outputs to the primary user via the output modules 18. The processing module 16 may be further adapted to provide the outputs to the second user(s) to facilitate the remote monitoring and interaction by the second user(s) with the primary user.

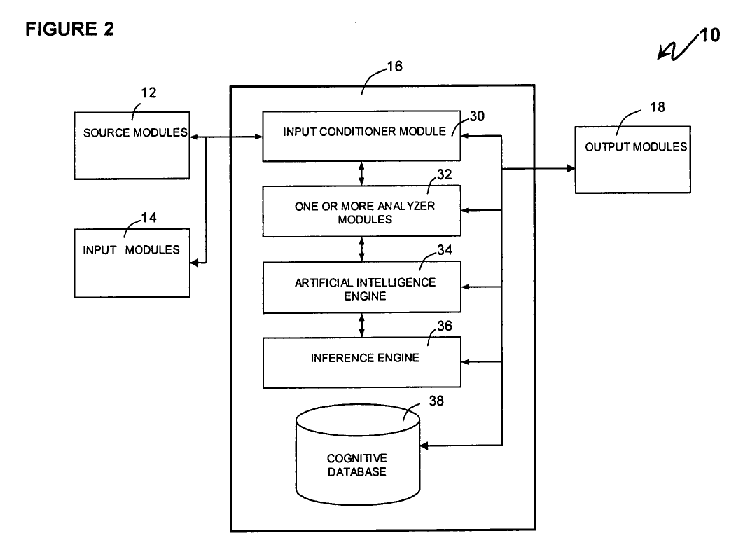

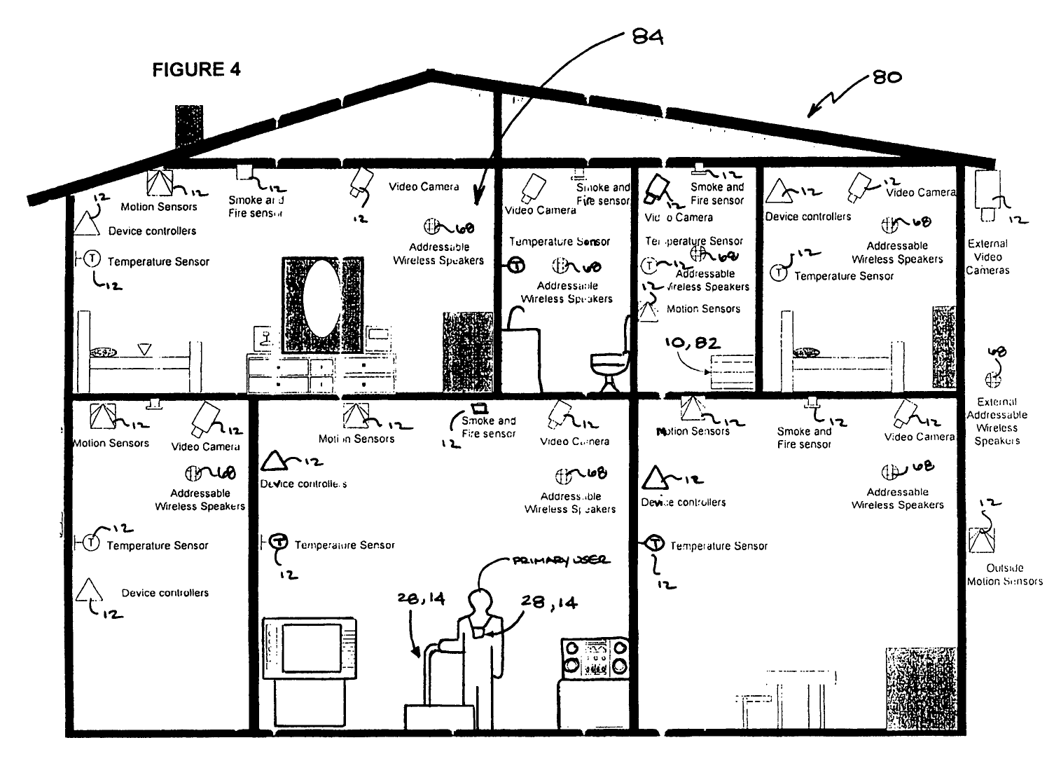

Referring to FIGS. 1 and 4, the source modules 12 are devices that are provided within the residence of the primary user to receive data concerning the condition and safety of the primary user's environment. The source modules 12 may also be adapted to receive information and data concerning the health of the primary user, for example, with minimal interference to the primary user's lifestyle and activities. For example, temperature sensors may be provided throughout the residence to gather and record information and data concerning the primary user's body temperature. This information and data may then be inputted by the source modules 12 to the system 10 for processing and review by the secondary user(s). In one embodiment of the system of the present invention shown in FIG. 2, the source modules 12 include one or more vision modules 20 having a camera means that may be provided throughout the residence so as to enable the primary user to interact with the system 10 and initiate various functions, such as turning the television on/off, dimming the lights in a room, or increasing the temperature on the thermostat. The camera means may also be utilized by the primary user to communicate with secondary users situated at a remote location, and to provide those individuals with information about their well-being. It should be understood that the camera means may be repositionable by the secondary users so as to enable them to observe the activities of the primary user, as well as the condition of their well-being and security.

The source modules 12 may also include one or more motion sensors that are adapted to monitor the position of the primary user within and surrounding their residence. The motion sensors may include infrared means to facilitate the determination of the position of the primary user during the evening and nighttime hours. Using the input received from the motion sensors, the system 10 may be programmed to automatically activate various functions within a room in the residence as the primary user enters that room. For example, the system 10 may be programmed to turn the lights on in the foyer as the primary user enters the residence. Similarly, the temperature may be increased by the system 10 as the primary user moves into a particular room.

It should be understood that the source modules 12 may include any suitable sensors and devices as are known in the art to enable the system 10 to receive inputs concerning the well-being, health and security of the primary user. For example, the source modules 12 may include RF-ID equipped sensors, temperature sensors, carbon monoxide, fire and smoke detectors, and pressure sensors. These source modules 12 will enable the system 10 to be continually updated with the most current inputs and information about the primary user. This information may then be used to make appropriate decisions about the operation of the system 10, and the well-being of the primary user.

The input modules 14 may include various devices conveniently located throughout the primary user's residence to enable the primary user to communicate inputs to the system 10. In an exemplary embodiment of the present invention, the input modules 14 include speech modules 22 having one or microphones to receive verbal inputs, such as requests, queries, instructions or other data, from the primary user. Moreover, the speech module 22 may be adapted to enable the primary user to communicate with a secondary user, such as a doctor, via the Internet or a telephone, cable, or satellite network. The input modules 14 may also include keypads and keyboards that the primary user may utilize to input keystroke queries and information into the system 10.

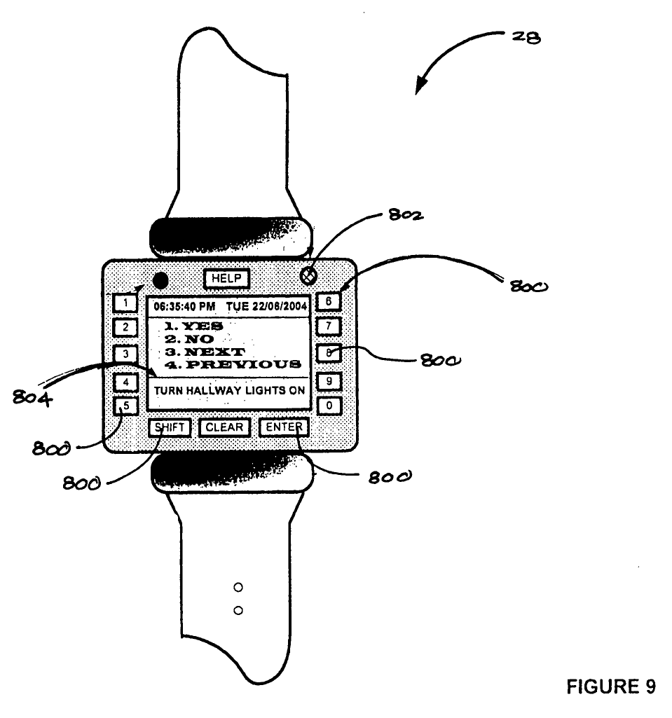

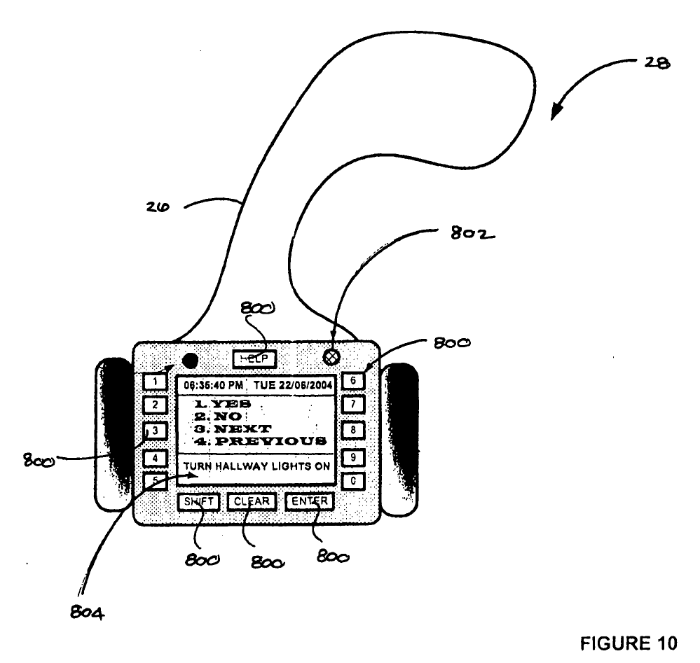

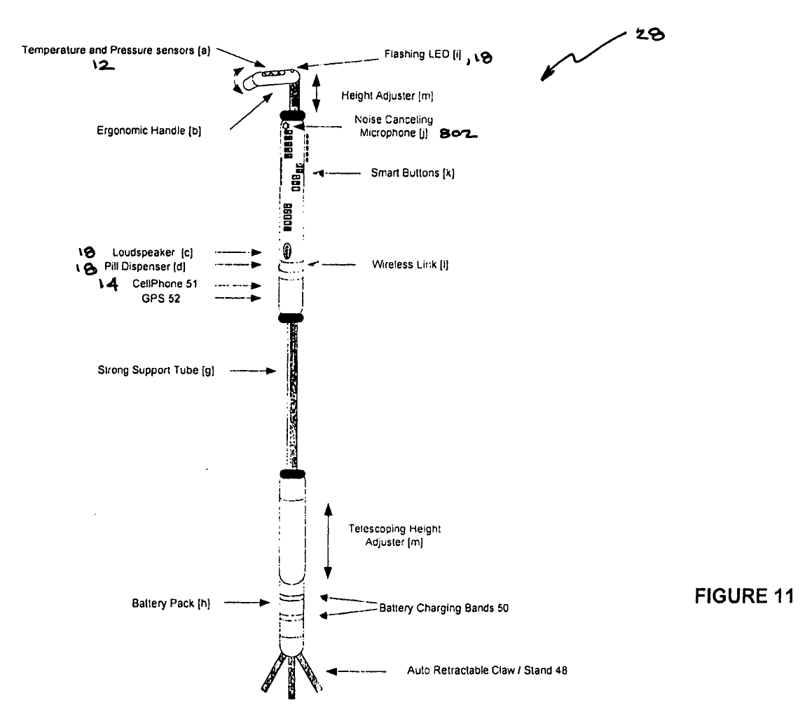

The input modules 14 may further include a portable communication device or fob module 28 that is capable of sending and receiving communications from the system 10. In one embodiment of the fob module 28 shown in FIG. 9, the fob module 28 is a wristwatch which may be secured around the arm of the primary user to facilitate the communication of one or more inputs to the system 10. In a second embodiment of the fob module 28 shown in FIG. 10, the fob module 28 resembles a pendant that may be provided around the neck of the primary user on a necklace 26. In a third embodiment of the fob module 28 shown in FIG. 11, the fob module 28 resembles a walking cane Each of the fob modules shown in FIGS. 9, 10 and 11 may include a series of buttons which are preprogrammed to provide one or more inputs from the primary user to the system 10, such as, for example, activating the speech modules 22 so as to enable the primary user to input and record a message or dates into the system 10, or contacting a secondary user in the event of an emergency. The fob module 28 may also be provided with a disable button which the primary user may use to disable the system 10 or any of the modules comprising the system 10 if the primary user does not wish to be monitored at a given time.

In an exemplary embodiment of the present invention, the system 10 may be adapted to scan for inputs communicated from the source modules 12 and/or the input modules 14 at regular intervals and, if necessary, initiate appropriate functions to notify secondary users if the primary user requires assistance or notify repair personnel if the system 10 is not operating as intended.

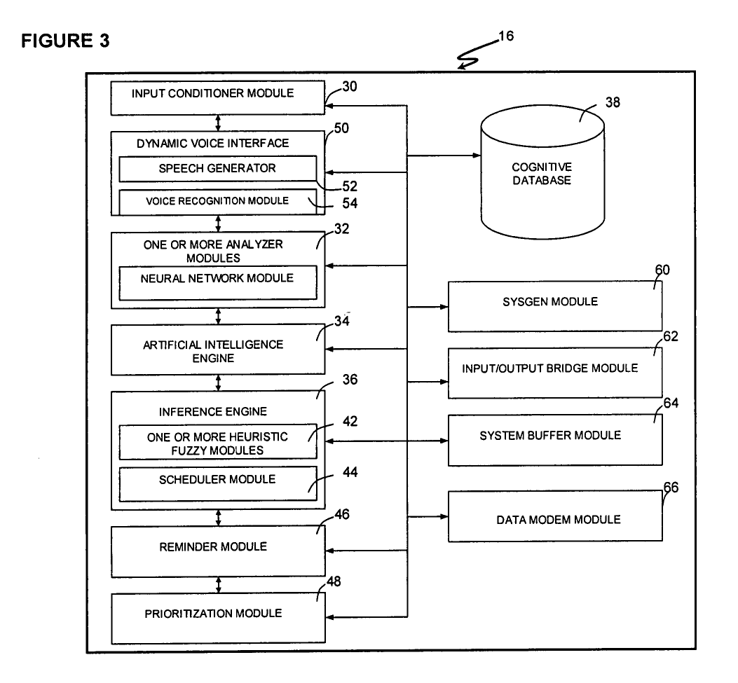

The one or more inputs received from the source modules 12 and the input modules 14 are communicated to the central processing module 16 for monitoring and processing. The central processing module 16 includes a network of interactive and dynamic modules that are designed to enable the system 10 to interact and communicate with the primary user in a human-like manner. Referring to FIGS. 2 and 3, the central processing module 16 includes an input conditioner module 30, one or more analyzer modules 32, an artificial intelligence engine 34, an interference engine 36, and one or more cognitive databases 38. The input conditioner module 30 is adapted to receive the one or more inputs from the source modules 12 and the input modules 14 within the residence of the primary user and/or from the primary user themselves. The input conditioner module 30 then regulates and normalizes the quality of the inputs, including the volume and signal strength of the inputs, before communicating the inputs to the one or more analyzer modules 32. A digital signal processor module 33 may be provided within the input conditioner module 30 to enable the performing of fast Fourier transform algorithms and spectral analysis to recognize and filter out noise and any other interference which may be communicated to the system 10.

The one or more analyzer modules 32 are configured to identify any contextual patterns in the information and data forming the inputs received from the source modules 12 and input modules 14. The one or more analyzer modules 32 may include a neural network module 40 consisting of a mathematical algorithm or model that is adaptive to the one or more inputs received from the source modules 12 and input modules 14 and the contextual patterns in the information and data. The neural network module 40 is adapted to identify and classify patterns in the inputs from the primary user so as to enable the system 10 to provide the correct one or more outputs or to initiate the correct monitoring and interactive functions with the primary user. If patterns are identified in the inputs, the one or more analyzer modules 32 communicate these patterns to the artificial intelligence engine 36.

The artificial intelligence engine 34 is adapted to examine the contextual patterns within the one or more inputs communicated by the primary user and to interpret these inputs in accordance with a series of parameters stored within the one or more cognitive databases 38. If the contextual patterns within the one or more inputs satisfy the series of parameters, and the system 10 is capable of interpreting the one or more inputs from the primary user, the one or more inputs will then be communicated to the inference engine 34. If the artificial intelligence engine 36 is unable to interpret the one or more inputs, the system 10 may be adapted to obtain one or more additional inputs from the primary user via the source modules 12 and/or the input modules 14.

The inference engine 36 is configured to generate one or more outputs and functions for communication to the primary user based on the contextual patterns within the one or inputs received by the system 10. The inference engine 36 utilizes a knowledge base containing all data, information, and commands, for example, received from the one or more source modules 12 and the one or more input modules 14 and stored in the one or more cognitive databases 38 from which the inference engine 36 is configured to generate the one or more outputs and functions, and to configure the operations of the system 10. The knowledge base may also include the particulars of the medical history, sleeping patterns, and other preferences of the primary user. The inference engine 36 may also utilize an external database containing, for example, travel schedules, financial quotes and weather information, which may be accessed by the system 10 in response to one or more inputs, such as requests and queries, from the primary user. Additional information may also be contained in the one or more cognitive databases 38 and external database from various personal care sources, as well as sources of specific interest to the primary user, such as hobbies, music and literature.

The one or more cognitive databases 38 are adapted to store and load the source inputs, user inputs, contextual patterns and other data received from the source modules 12 and the input modules 14. The cognitive databases 38 are further adapted to store the outputs generated by the system 10, and to enable the system 10 to access and retrieve any of the contextual patterns, parameters, inputs and outputs stored in the databases 38. The cognitive databases 38 may be dynamically designed to receive and store new inputs, contextual patterns, parameters and outputs, for example, received from the primary user and/or the secondary user(s). By this design, the dynamic updating of the cognitive database 38 enables the system 10 to adapt to the evolving preferences and requirements of the primary user and the varying conditions within the residence. In embodiments of the present invention, the cognitive databases 38 may operate in conjunction with a larger database of inputs, contextual patterns, parameters, outputs or other data, such as a database or information resource that may be searched by, for example, any Internet search engine, when analyzing the source inputs from the one or more source modules and the user inputs directly from the primary user and generating one or more outputs. Moreover, the various inputs, contextual patterns, parameters, outputs and/or other data stored in the databases 38 may exist in a single database or other storage means, or be distributed across multiple databases or other storage means.

In a further embodiment of the present invention shown in FIG. 3, the inference engine 36 may include one or more heuristic fuzzy logic modules 42 and a scheduler module 44. The heuristic fuzzy logic module 42 may be adapted to provide an initial value or “seed” to the inference engine 36 to facilitate the generation of one or more outputs and functions in response to the inputs of the primary user. The heuristic fuzzy logic module 42 is further adapted to communicate with the inference engine 36 to facilitate the variation and mutation of the decision making processes of the inference engine 36. By this design, the one or more outputs and functions generated by the system 10 and stored in the one or more cognitive databases 38 will continually evolve in view of the inputs received from the primary and secondary users via the source modules and the input modules. The heuristic-fuzzy logic module 42 will further enable the system 10 to adapt to the changing preferences, desires, and requirements of the primary user by ensuring that the one or more inputs, the contextual patterns, and the one or more outputs stored in the databases 38 do not become stagnant.

The scheduler module 44 of the inference engine 36 is adapted to maintain the data and time sequence of the one or more outputs communicated to the primary user and/or the secondary user(s). The scheduler module 44 may be further adapted to generate scheduled triggering events upon the occurrence of which the inference engine 36 is instructed to generate one or more outputs to the primary user and/or secondary users. The triggering events may be established by the scheduler module 44 based on the inputs, contextual patterns, and outputs stored in the one or more cognitive databases 38. It should be understood that the scheduled triggering events may be one-time occurrences (such as a reminder to attend a wedding), or repetitive, multiple events (such as weather updates or reminders to take medication). Upon the completion of the generation and communication of the one or more outputs and functions to the primary user and/or secondary user(s), the inference engine 36 may be adapted to notify and update the scheduler module 44 so as to ensure that the outputs and/or functions are not unnecessarily repeated and to maintain the performance of the system 10. The scheduler module 44 may also be adapted to perform a series of functions and actions based on the one or more outputs generated by the inference engine 36. For example, the scheduler module 44 may be adapted to perform a pre-determined “Sunday Morning Routine”, including playing soft music, turning the coffeemaker on, and announcing the wake-up time, to gently rouse the primary user in the morning.

In further embodiments of the system 10 shown in FIG. 3, the central processing module 16 may include a reminder module 46 which is configured to maintain and retrieve the inputs, contextual patterns, outputs, parameters and other data provided to the analyzer modules 32 and inference engine 36. Based on these inputs, contextual patterns, outputs, parameters and other data, the reminder module 46 is configured to communicate one or more outputs concerning the events and activities of interest to the primary user, such as, for example, appointments and to-do lists for a specified period of time. The reminders may be communicated to the primary user at pre-determined intervals or randomly, using visual and/or audible communications from the one or more output modules 18.

Reminder module 46 is preferably adapted to remind the primary user of a particular event or activity that they must attend to. In this manner, the reminder module 46 operates as a “memory jog” for the primary user. Often it is not necessary for the reminder module 46 of the system 10 to receive confirmation in the form one or more user inputs from the primary user that the “memory jog” has been acted upon. Rather the reminder module 46 of the system 10 may be adapted to perform a follow-up analysis of the various data inputs gathered and stored in the one or more cognitive databases 38 to determine whether the primary user has fulfilled the event or activity pertaining to the “memory jog”. For example, the reminder module 46 may remind the primary user to change the battery in the carbon monoxide detector. Within a pre-determined period of time after the reminder was communicated to the primary user, the reminder module 46 may perform analysis of the system 10 to determine whether the old battery in the carbon monoxide detector has been replaced. If not, the reminder module may notify the primary user at a pre-determined later date to change the battery.

The central processing module 16 may also include a prioritization module 48 that is adapted to determine the most recent mathematical algorithm or model utilized by the analyzer module 32, and to prioritize the data and the plurality of inputs received from the primary user in accordance with the analyzer module 32. For example, if the system 10 is scheduled to remind the primary user that he must eat lunch, and simultaneously data is received from one or more of the source modules 12 indicating that a fire situation has occurred within the residence, the system 10 will activate a fire alarm or related output module within the residence to warn the primary user of the situation prior to notifying the primary user that it is time to eat lunch. By this design, the system 10 is capable of prioritizing the data, the one or more inputs and/or the one or more outputs so as to adapt to the requirements of the primary user and the conditions within the residence. The system 10 is adapted and programmed to automatically adapt to the current and past data, inputs and outputs retrieved from the database 38, the source modules 12 and the input modules 14 when generating the one or more outputs and functions to the primary user and/or secondary user(s).

The central processing module 16 may also include a dynamic voice interface 50, which is programmed to receive one or more inputs from the primary user via the one or more input modules 14 in the form of verbal, audio, speech and/or any other forms of communication. The voice interface 50 receives the primary user's verbal one or more inputs and generates one or more signal strings, which represent the primary user's verbal inputs. The signal strings may be text or character strings that represent the primary user's inputs into the system 10 and for which the primary user may be requesting one or more outputs, functions or other types of interactions and communications from the system 10. In one example, the primary user may ask the system 10 for the current time by stating “What is the time?”, to which the system 10 would communicate the current time to the primary user. In another example, the primary user may ask the system 10 to “Please increase the temperature in the living room by 2° Celsius”, in response to which the system 10 would accordingly adjust the thermostat. It should be understood that the voice interface 50 may use any known method or techniques to generate the one or more signal strings that represent the primary user's inputs.

The dynamic voice interface 50 may also include a speech synthesizer or generator 52 that is programmed to communicate interactively with the primary user in the form of synthesized speech, such as providing verbal reminders or reading literature to the primary user, or requesting additional one or more inputs from the primary user. The speech generator 52 may utilize “word stitching” and “phrase stitching” techniques to communicate one or more outputs generated by the inference engine 36 in the form of synthesized speech. Word or phrase stitching is designed to enable the system 10 to utilize an initially limited number of dictionary words in combination to create an extensive interactive vocabulary. The dictionary of words and phrases utilized by the system 10 may be stored and organized in a word/phrase dictionary 72 in accordance with various categories of subject matter.

The speech generator 52 may also be dynamically adapted to utilize word and phrase stitching to generate new and random vocabulary so as to enhance the primary users interactions with the system 10. In this respect, the speech generator 52 may be adapted to dynamically vary the words and phrases contained in successive one or more outputs communicated by the system 10 to the primary user. Moreover, the volume, timbre, speed, tempo and pitch of the synthesized voice may be automatically altered by the speech generator 52 to enhance the naturalness or human-like interaction between the primary user and the system 10. For example, the volume of an output communicated by the system 10 for a fire warning may be considerably louder than an output reminding the primary user to take their medication.

The dynamic voice interface 50 and the speech generator 52 may comprise a multilingual voice component that is adapted to communicate with the primary user and/or the secondary user(s) in a variety of languages stored in the one or more cognitive databases 38. In addition, the dynamic voice interface 50 and the speech generator 52 may be further adapted to provide verbal translations of various data and outputs, for example, that the primary user has requested from the system 10 via one or more user inputs.

In a further embodiment of the present invention, the dynamic voice interface 50 may include a speaker independent interactive voice recognition module 54 to enhance the ease with which the primary user may communicate and interact with the system 10. The interactive voice recognition module 54 may be based on a tunable speaker independent vocabulary which utilizes statistical analysis and context sensitive prediction analysis techniques to determine the one or more verbal inputs from the primary user. Over a period of use by the primary user, the interactive voice recognition module 54 of the system 10 will become accustomed to the particular voice and accent of the primary user, thereby resulting in a higher rate of recognition of the primary user's one or more inputs.

The interactive voice recognition module 54 is further adapted to analyze one or more inputs of unexpected intended input data communicated to the system 10 by the primary user. An unexpected intended input relates to one or more inputs and data received by the system 10 from the primary user that do not correlate to the current context of the interaction(s) with the primary user. For example, if the system 10 has been interacting with the primary user with respect to the schedule of activities for the current day, the system 10 may expect to receive questions relating to these activities, such as “When is my next appointment?” or “When is my lunch meeting?” In view of this current context of interactions with the primary user, if one or more inputs are received from the primary user which do not relate to the schedule of activities, such as “Please play music” and “Turn on the coffeemaker”, these one or more inputs represent unexpected intended inputs. The system 10 will analyze the one or more inputs of unexpected intended inputs and determine whether the primary user actually intended to communicate the one or more inputs to system 10. If the system 10 determines that the primary user did intend to communicate the one or more inputs of the unexpected intended input data to the system 10, the inference engine 36 of the one or more analyzer modules 32 will generate one or more outputs based on the one or more inputs (such as turning on the radio or coffeemaker). The ability of the system 10 to receive, analyze and respond to unexpected intended inputs from the primary user's one or more user inputs enables the system 10 to achieve a high recognition rate of the one or more user inputs in a wide variety of contexts. The multilingual capabilities of the system 10 further enhance the recognition of the one or more user inputs from a primary user interacting with the system 10 in a multitude of languages, such as English and German.

Each of the primary users and the one or more secondary user(s) may each have unique requirements, expectations and personalities when interacting with the system 10. The system 10 may be programmed with pre-set “genetic” or “human” characteristics, such as voice and language characteristics, when the system 10 is initially manufactured. The primary user and the one or more secondary users, such as system administrators and qualified caregivers, for example, may alter these pre-set characteristics to accommodate the preferences and requirements of the primary user using an interactive sysgen module 60, as shown in FIG. 3. By connecting with the system 10 from either a local or remote location, the secondary user may interactively alter the various data, information, commands and/or parameters of the system 10 using the sysgen module 60. Initial data and information concerning the primary user's name, age group and preferences may be inputted into the one or more cognitive databases to provide the inference engine 36 with one or more contextual patterns when generating the one or more outputs to the primary user. It is also understood that the preferences and requirements of the one or more secondary users may also be inputted into the system 10 using the sysgen module 60.

The sysgen module 60 may be initiated at anytime by the primary user and/or a secondary user to change the data, information, commands and/or parameters in the system 10, and to access the one or more cognitive databases 38, so as to fine tune the system 10. The sysgen module 60 may be further adapted to simulate the affect of the one or more modifications to the data, information, commands and/or parameters on the system 10 before allowing or initiating the modifications in actual use. This will ensure that the proposed modifications do not interfere with the primary user's use and enjoyment of the system 10.

In a further embodiment of the present invention, the system 10 preferably includes an input/output bridge module 62 that is adapted to enable the system 10 to interface with appliances, equipment and other technology presently located within the primary user's residence or office. For example, the system 10 of the present invention may be coupled or interfaced with existing security, home entertainment and smart home systems provided within the residence of the primary user. Moreover, the input/output bridge module 62 may be designed to interface with a wide variety of appliances within the residence, including, but not limited to, food dispensers, coffee, tea and soup makers, pill and medicine dispensers, and televisions and radios. The sysgen module 60 may be further adapted to configure the input/output bridge module 62 so as to enable the system 10 to be used with these existing appliance, for example, thereby enabling the system 10 to utilize the functionality of the existing equipment and technological devices within the primary user's residence and allowing the primary user to retain familiar devices. The input/output bridge module 62 may include one or more input and output connections, such as digital, analog and infrared connections, that enable the system 10 to gather and receive one or more source and user inputs from the one or more source and user input modules throughout the residence and the primary user. It should be understood that the input/output bridge module 62 is further adapted to accommodate any suitable power line interfaces, such as, for example, X-10, to control technological devices such as curtain openers, lights, fans and heat ventilation and air conditioning (HVAC) devices. The input/output bridge module 62 is extensible, thereby enabling the number of device with which system 10 interfaces to be increased.

The system 10 may be further provided with a system buffer module 64 that is programmed to analyze the one or more source inputs, one or more user inputs and any remote communications entering the system 10. For example, the system buffer module 64 may include a firewall adapted to secure the one or more cognitive databases 38 to prevent the interference of viruses, spyware and other parasitic computer applications with the primary user's use of the system 10. Moreover, the system 10 may be designed to have a single point of access via the system buffer module 64 to prevent the interference of viruses. All data, information, commands and/or parameters, including the source inputs, user inputs and outputs, communicated to and from the system 10 to a secondary user at a remote location may be encrypted and secured with any suitable encryption technology and methodology, such as a key and a cyclic redundancy check (CRC).

The system buffer module 64 may also be adapted to intercept or reroute telephone calls or other communications while the primary user is busy with other activities, such as sleeping or attending an event outside of the residence. The system buffer module 64 may screen and discard unwanted telephone calls, messages and other communications from telemarketers or third parties not recognized by the system 10 or expressly blocked by the primary user and/or the secondary user(s). For example, when a telephone call is made by a secondary user to the primary user, the system 10 may be adapted to answer and receive the telephone call without the telephone ringing within the residence. System 10 may then be programmed to provide a message to the secondary user, such as “Hello! Would you like to speak with the primary user? Who may I say is calling?” If the system 10 receives an input from the caller, and that caller is not expressly blocked by the primary user, it will then ring the telephone or the addressable speaker(s) within the residence and announce the name of the caller to the primary user. The system buffer module 64 may also be adapted to observe pre-set “Do not disturb” times established and inputted by the primary user into the system 10, such as, for example, times during which the primary user naps or meditates.

Additionally, the system 10 may require that the secondary user or third party caller to input a combination of touch tone inputs, and/or provide an input or answer to a random question stored in the one or more cognitive databases 38 (for example, “What is the primary user's birth date?”). If the input to the random question is correct, the system 10 may then ask the caller the reason for the call and record and store this input and other data in the one or more cognitive databases 38 for security audit purposes, and then allow the secondary user-caller to communicate with the system 10 or the primary user via touch tone sequences or voice inputs. The secondary user-caller may then interact with the system 10 to review the activity or input log of the primary user and/or a secondary user, to initiate one or more outputs within the primary user's residence, such as, for example, turning on the lights, or to modify the contextual patterns, parameters, and/or other data stored in the system 10. A transcript of the activities and modifications made by the secondary user may be stored in the one or more cognitive databases 38.

For primary users located in rural regions, the system 10 has an integral data modem module 66 which is programmed to enable the transmission of the one or more source and user inputs, outputs and other data from the system 10 to and from remote locations. In order to enable the primary user to utilize electronic mail (e-mail) functions and other technologies with which they are unfamiliar, the data modem module 66 may be adapted to record one or more user inputs received from the primary user verbally, and to transmit these one or more inputs to a secondary user, for example, as an attachment to an email. The primary user may simply verbally state the name of the person or organization to whom the email message is being sent, and the subject line of the email, if necessary. If the primary user receives an email message from a secondary user or a third party, the dynamic voice interface 50 and the data modem module 66 of the system 10 may be adapted to read the email message aloud to the primary user via the one or more outputs. By this design, the system 10 enables the primary user to maintain social interactions and connections with various secondary users and third parties, including family members, friends, caregivers and medical personnel, regardless of whether they own a traditional computer device or possess sufficient proficiency at utilizing computers.

In addition to transmitting and receiving email messages for the primary user, the data modem module 66 and the one or more analyzer modules 32 may also be programmed to analyze one or more inputs or functions contained in the email message and to generate one or more outputs via the inference engine 36. If the email message is received from secondary user who is authorized to alter the various data, information, commands and/or parameters of the system 10, the system 10 may initiate and generate the one or more outputs. For example, if the primary user is participating in a continuing education course at a local college, the primary user may authorize the professor to communicate an email message containing data, such as assignment deadlines and reminders, to the system 10 via the modem module 66. Upon receipt of the email message, the system 10 may store the data contained in the email message in the one or more cognitive databases 38, scheduler module 44 and/or the reminder module 46. It should be understood that the primary user may also communicate with the system 10 and provide one or more user inputs, such as personal reminders, from a remote location.

The central processing module 16 preferably has sufficient capacity to monitor and interact with the primary user and the one or more secondary users simultaneously in real-time, thereby enhancing the usability and naturalness of the system in use. Furthermore, the central processing module 16 is designed to control at least the monitoring and interaction functions of the personal management system 10 of the present invention. Preferably, the central processing module 16 is dimensioned to be contained within a bureau, end table or like piece of furniture or disguised as a set of books within the residence of the primary user. Concealing the central processing module 16 within a piece of furniture will likely result in the greater adoption of the present invention by elderly and physically challenged individuals who may be unfamiliar with the technology.

In embodiments of the present invention, system 10 comprises of one or more output modules 18 that enable the system 10 and secondary users to communicate and interact with the primary user. In an exemplary embodiment, the output modules include one or more addressable speakers 68 which are adapted to communicate audible messages within the residence to the primary user. Based on the inputs received from the source modules 12, the system 10 may be adapted to determine the location of the primary user within the residence and to communicate with the primary user through one or more addressable speakers 68 in the vicinity of the primary user. By this design, the primary user's partner, family members or other secondary users will not be unnecessarily disturbed by the system 10 unless a general broadcast communication is required, as in the case of an emergency. Moreover, the use of addressable speakers 68 will ensure the security of the communications between the system 10 and the primary user will not be compromised.

In an exemplary embodiment of the present invention, the addressable speakers 68 include a microprocessor having a unique address which enables the system 10 to selectively communicate to one or more addressable speakers 68 based on an address specific to those one or more speakers. The microprocessor within the subject addressable speaker 68 is adapted to detect the transmission of this address from the system 10 and to output the verbal commands, data or other information communicated from the system 10. These verbal commands may include additional queries for the primary user or functions requested by the primary user, such as playing a music CD or the radio. It should be understood that the communications from the system 10 to the addressable speakers 68 may be wired or wireless. Furthermore, the addressable speakers 68 may be Bluetooth® based or operate from a power-line carrier. The protocols employed to facilitate communication between the system 10 and the addressable speakers 68 may be TCP/IP, UDP or any other proprietary protocols used by persons skilled in the art.

It should be understood that the outputs sent by the system 10 to the addressable speakers 68 may be persistent, such as volume control settings, and may be stored in the local memory of the microprocessor provided within the speakers 68. In instances where the outputs contain a larger volume of information, such as MP3 music, the addressable speakers may be provided with recordable disk capacity. Furthermore, it should be understood that the addressable speakers may be bundled with the source modules 12 and the input modules 14 so as to minimize the space, resources and power outlets required to operate the system 10 within a residence.

Although many of the embodiments of the present invention described herein do not require the primary user to provide one or more inputs via traditional computing means, such as computers, keyboards or touch-screen visual displays, for example, it should be understood that such input modules may be required or advantageous for some primary users. For example, the use of keyboards and touch-screen displays may be necessary for primary users having hearing impairments. For these primary users, the system 10 may be adapted to communicate the one or more outputs (e.g. reminders, weather updates) through a visual display, such as computer monitor and television. The system 10 may then also accept one or more inputs form the use through a touch screen visual display. If the primary user of the system is a child or a family with children, the use of visual input and output modules 14 and 18, respectively, may improve the monitoring and interaction between the child-primary user and the system 10.

It is recognized that any suitable hardware, software and/or any combination thereof may be utilized to configure, program and/or implement the personal management system 10, including the source modules 12, the one or more input modules 14, the central processing module 16, the one or more output modules 18 and the cognitive databases 20 in accordance with embodiments of the present invention.

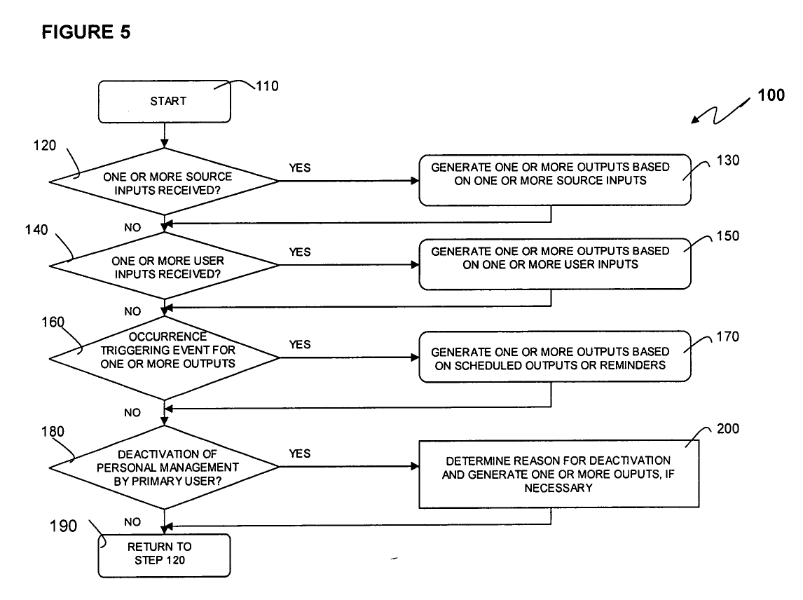

Reference is made to FIGS. 5 through 8 in which the steps in an embodiment of a method for monitoring and interacting with a primary user are shown generally as 100, and commence at step 110. At step 120, system 10 determines whether one or more source inputs have been received from the one or more source modules. If one or more inputs have been received from the source modules at step 120, the method proceeds to step 130 where the system 10 performs the steps for analyzing and generating one or more outputs. If no source inputs have been received from the one or more source modules concerning the condition of the primary user and/or the residence, the method proceeds to step 140.

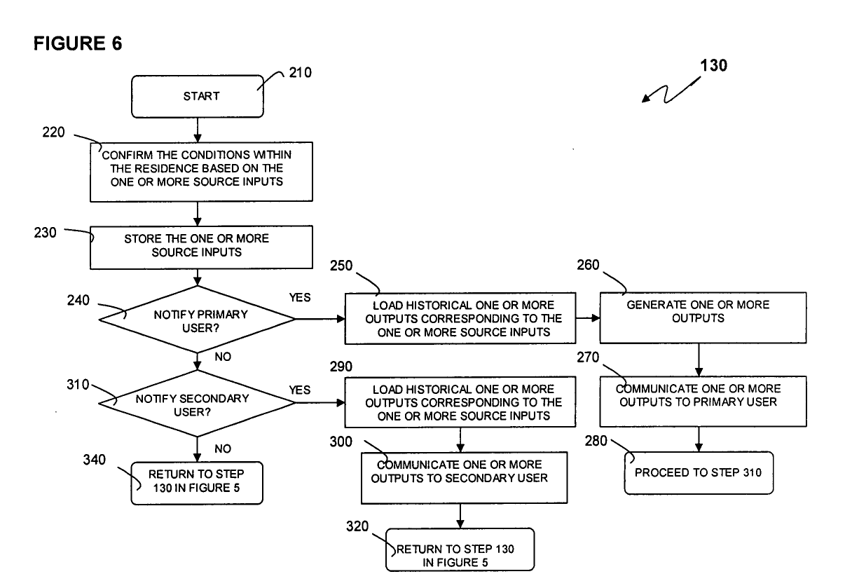

Reference is made to FIG. 6 which illustrates the method at step 130 of FIG. 5 of analyzing and generating one or more outputs based on the one or more source inputs received by the source module. At step 220, the system 10 may analyze and confirm the conditions within the residence based on the one or more source inputs. For example, a fire detector source module located in the kitchen of the primary user may indicate and input the occurrence of a stove fire to the system 10. At step 220, the method would confirm whether the source input from the smoke detector source module is valid or whether the source module is simply malfunctioning (e.g. low battery warning). The method proceeds to step 230, where the system 10 stores the one or more source inputs in the one or more cognitive databases 38. At step 240, the one or more analyzer modules 32 and the inference engine 36 determine whether to generate one or more outputs notifying the primary user of the condition within the kitchen. If it is determined that the primary user should be notified, the method proceeds to step 250 where the system 10 loads any historical one or more outputs that have been communicated by the system 10 in response to similar or identical source inputs from the fire detector source module. The system 10 analyzes whether any of the historical one or more outputs generated are applicable in the current context of the source input from the fire detector module. The historical one or more outputs from the system 10 may have instructed the primary user to immediately evacuate the residence or remove a pot from the stove. The method would then proceed to step 260 where the inference engine determines whether any of the historical one or more outputs generated by the system are appropriate in the current context. If the historical outputs are not appropriate in the current context, the system 10 generates dynamic one or more outputs for communication to the primary user at step 270 in accordance with various contextual patterns, parameters, and other data stored in the one or more cognitive databases 38. Following the communication of the one or more outputs by the output modules, the method ends at step 280, and returns to step 130 of FIG. 5.

Continuing with the example of the source input received by system 10 from the fire detector source module in the kitchen, if, at step 240, the method immediately determines that the primary user need not be notified of the source input, the method proceeds to step 310. At step 310, the method then determines whether or not to notify the one or more secondary users of the condition within the kitchen. At step 290, the method loads the historical one or more outputs corresponding to the source inputs received from the fire detector source module, and determines whether such outputs are applicable in the current context. If a fire condition has occurred in the kitchen, the system 10 may communicate an emergency distress output to the fire department and/or ambulance services at step 300. Similarly, if it was determined that the fire detector source module was malfunctioning, the system 10 may communicate a maintenance request output to a secondary user-repair technician at step 300. After the one or more outputs have been communicated to the secondary user(s), the method proceeds to step 320 and returns to step 130 in FIG. 5. It should be understood that the system is adapted to generate and communicate a wide variety of one or more outputs to the primary user and/or the secondary user(s) based on the on the inputs.

Following the completion of the steps 130 in FIG. 6, the method proceeds to step 140 in FIG. 5. At step 140, the system 10 determines whether one or more user inputs have been received from the primary user via the one or more inputs modules. The inputs received from the primary user may be of varying complexity. For example, the primary user may simply input a request for the time at step 140. At step 150, the system would generate one or more outputs based on the users inputs via the input modules. The primary user may provide complex inputs and requests, such as the recording and storage of their memoirs for posterity. In one embodiment of the present invention, the system and method is adapted to assist the primary user with the preparation and recording of their memoirs by prompting the primary user with one or more outputs in the form of questions at step 130 to trigger their memory, such as, for example, “Tell me about the city in which you were raised.”

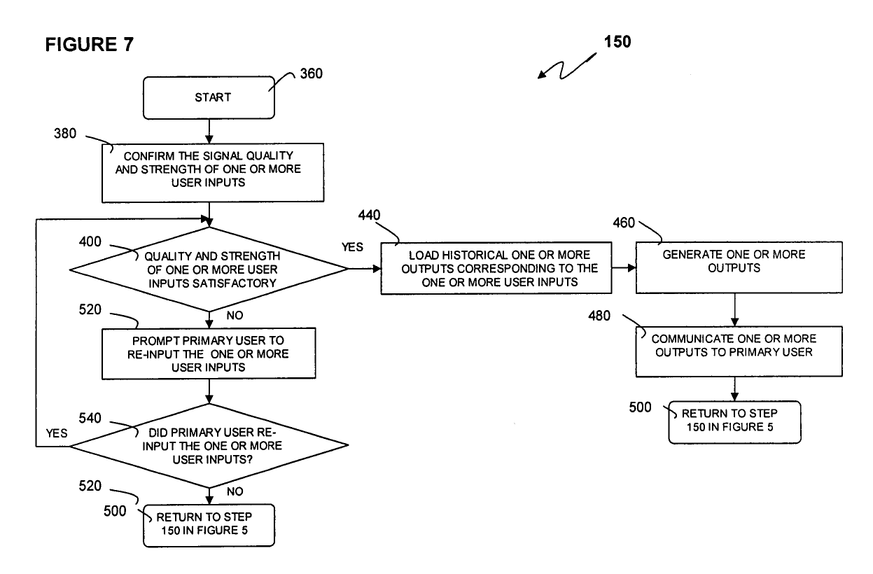

Reference is made to FIG. 7 which illustrates the method at step 150 of FIG. 5 of analyzing and generating one or more outputs based on the one or more user inputs received from the primary user, and commences at step 360. At step 380, the method confirms the signal quality and strength of the one or more user inputs from the primary user. Then, at step 400, it is determined whether the signal quality and strength of the user inputs are satisfactory for analysis by the system 10. If the quality and strength of the user inputs is satisfactory, the method proceeds to step 440 and loads the historical one or more outputs corresponding to the primary user's one or more user inputs. For example, if the primary user wishes to continue recording his/her memoirs, the method of the present invention may load the last user inputs for the memoirs stored by the system. At step 460, one or more outputs may be generated based on the user inputs, such as summary of the primary user's most recent addition to his/her memoirs or further questions to assist the primary user with the continuing recording of their memoirs. A secondary user knowledgeable of the primary user's life and experience may also be able to provide the system 10 with questions to assist the primary user with the completion of their memoirs. The one or more outputs generated by the system 10 at step 470 may be communicated the primary user via the one or more output modules at step 480.

In a further example of the steps 440 through 480, the primary user may submit a user input requesting that the system contact a particular secondary user. At step 440, the system 10 would determine the current contact particulars for the secondary user based on the most recent data stored in the system. At step 460, the method would generate one or more outputs, such as, for example, instructing the system 10 to dial the secondary users telephone number and activating the various input modules to enable the primary user to verbally communicate with the secondary user. The following the completion of the communication of the one or more outputs from the system 10 at step 480, the method proceeds to step 500. At step 500, the method returns to step 150 in FIG. 5.

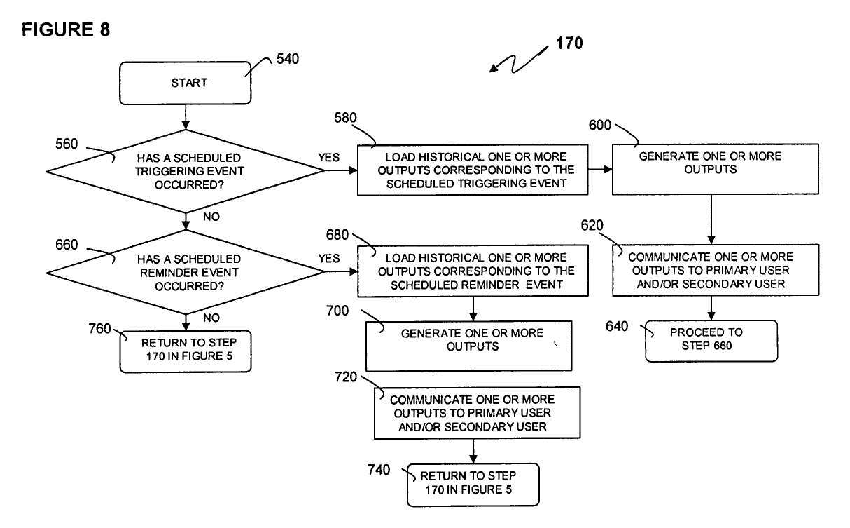

Following the completion of the steps 150 in FIG. 7, the method proceeds to step 160 in FIG. 5. At step 160, the system 10 determines whether the one or more triggering events for scheduled activities and/or reminders have occurred within the system 10. If a triggering event has occurred, the method proceeds to step 170 to determine whether one or more outputs must be communicated to the primary user. Reference is made to FIG. 8 which illustrates the method at step 170 of FIG. 5 of analyzing and generating one or more outputs based on the one or more triggering events, and commences at step 540. At step 560, the system 10 determines whether a triggering event scheduled by the primary user, a secondary user and/or the system 10 has occurred. For example, the triggering event may be an event that the primary user commonly participates in, such as a prayer session or a morning wake-up ritual as discussed earlier. The system 10 at step 580 may load historical one or more outputs corresponding to the schedule triggering event. The example of the prayer session triggering event, the system 10 may load the primary user's favorite prayers or versions from a religious book or identify the religious television programs that the primary user commonly watches. The method at step 580 may also be adapted to load various data and information pertaining to the triggering event, such religious practices, holidays and observances, from external databases. It should be understood that the triggering events at step 560 may consist of a wide variety of activities, events and other data that may be used to remind the primary user.

At step 600 of FIG. 8, the method of the present invention generates one or more outputs based on the scheduled one or more triggering events for communication to the primary user and/or a secondary user at step 620. Depending on the nature of the triggering events, the system 10 may not communicate the one or more outputs directly to the primary user and/or secondary, but will simply initiate the corresponding function within the residence. For example, at 9 PM every evening the system 10 may be triggered to automatically lock the exterior doors of the residence, or play the primary user's favorite radio program. The one or more outputs for the triggering event(s) are communicated at step 620 via the appropriate one or more output module or other module within the system 10. Following the completion of the communication of the one or more outputs from the system 10 at step 620, the method proceeds to step 640 and then 660 in FIG. 7.

At step 660, the method of the present invention determines whether a scheduled reminder event has occurred within the system 10 for which one or more outputs are required. The method proceeds to step 680 where the historical one or more outputs corresponding to the scheduled reminder event are loaded for analysis by the system 10 at step 700. The system 10 then generates one or more outputs predicated on the historical one or more outputs for similar or identical triggering events. The system 10 preferably alters the one or more outputs when reminding the primary user of the occurrence of a triggering event so as to ensure that the repetitive reminders do not fatigue the primary user. Using the dynamic word and phrase stitching capabilities of the system, new outputs may be continually generated by the system 10 to motivate the primary user. The generated one or more outputs corresponding to the triggering events may then be communicated to the user at step 720, after which the method returns to step 170 in FIG. 5. If no scheduled triggering events or reminder triggering events have occurred, the method at step 760 also returns to step 170 in FIG. 5.

Referring to FIG. 5, the method at step 170 then proceeds to step 180 to determine whether the primary user has deactivated the system 10. If the system 10 has been deactivated, the method determines at step 200 whether the deactivation was caused by one or more user inputs or a power failure, for example. A primary user may choose to deactivate the system 10 using the fob module 28, for example, if they desire privacy or do not wish to be disturbed by one or more secondary users. If the deactivation is the result of a power failure, one or more outputs may be automatically generated by the system 10 and communicate to one or more secondary users to coordinate the repair of the system. The method then proceeds to step 190, and a further iteration of steps 120 through 190 of the method of the present invention is performed.

In use, the system, method and device of the present invention may be used by a primary user to receive interactive assistance with the monitoring and managing of their personal care. The system 10 is adapted to provide the primary user with a wide variety of outputs, functions and data to enable the primary user to better organize and manage their day-to-day activities. When being used to monitor and manage the personal care of an elderly primary user, the system 10 provides a user-friendly and interactive means for the primary user to communicate with secondary users, such as family members, acquaintances and medical personnel, via the Internet, fax, or other technological means, despite the primary user's inexperience and lack of knowledge as to the use of such technological means. When used in an elderly primary user's residence 80, it should be understood that the system 10 may be discreetly positioned within a bureau, cabinet or closet. For example, referring to FIG. 4, the system 10 of the present invention is located within a bureau 82 on the second floor 84 of the residence 80. By this design, the elderly primary user will less likely be intimidated by or deterred from using the present invention since they will not be required to directly interact with a traditional computer interface.

Referring to FIG. 4, utilizing one or more source modules 12, such as video cameras 86, motion sensors 88, smoke and fire sensors 90, temperature sensors 92, RF-ID tags, and device controllers 94, for example, and one or more and one or more input modules 14, the system and method of the present invention is further adapted to enable both a primary user and a secondary user interacting with the system 10 to continually monitor and manage the conditions within and surrounding the primary user's residence and the overall well-being of the primary user. For example, if the system 10 determines that the primary user is alone in their bedroom on the second floor of the residence, it may automatically turn off the lamps and appliances situated on the lower level. Similarly, if a secondary user visits the residence 80, the system 10 may notify the primary user that the secondary user has arrived. If an unknown third party arrives at the residence in the middle of the night, the system 10 of the present invention may be programmed to assume that the individual is hostile and take appropriate defensive actions, such as generating one or more outputs to turn on the exterior lights or alarms or confirming that the exterior doors are locked.

The primary user may communicate with family members and friends using video conferencing technologies provided as output modules with the present invention. The system 10 and method may also be used in a family setting consisting of one or more parents and children. For such family users, the present invention may be used to centralize the organization and management of the family, a role typically performed by a stay-at-home member of the family. The organization and management of the family may include coordinating the schedules of each member of the family, providing wake-up notices, exercise regimes, televisions viewing and homework schedules, for example. Further, household chores may also be monitored and managed by the system 10 and method of the present invention, including the feeding of the family pet, drawing the curtains at dusk, vacuuming the floor, and sounding an alarm in the event of a fire or other catastrophic event.

In further embodiments of the present invention, the one source modules 12 may include telemedicine components, such as heart, pulse, respiratory monitors, electrocardiograms, pulse measurement devices and blood pressure devices. The system 10 may be adapted to monitor these telemedicine components and to notify secondary users, such as medical personnel and family members. Moreover, the system 10 may be may also be adapted to monitor and record the inputs from the telemedicine components as well as the activities and habits of the primary user to enable the detection of trends and health conditions by the secondary users. The records from the telemedicine components may be communicated to the secondary users in accordance with a pre-determined scheduled triggering event or may be access on-demand by the secondary users from the cognitive database 38.

In a further embodiment of the present invention, the fob module 24 shown in FIGS. 9, 10 and 11 is a portable communication device consisting of both source module 12 and input module 14 components which are adapted to provide one or more source inputs and one or more user inputs to the system 10. The fob module 24 may be used by the primary user to provide the substantially all of the source inputs and user inputs and to communicate with the secondary users. However, it should be understood that the fob module 24 may be used in conjunction with the other one or more source modules and one or more input modules. As discussed earlier within this application, the fob modules 24 may include a series of buttons 800 which are pre-programmed to communicate various source and user inputs to the system 10. Each of the buttons 800 may be dynamically programmed to provide different inputs outputs and functions depending on the current context, such as, for example, the location of the primary user with the residence. The fob module 24 may also include a voice input means 802, such as a microphone, which will enable the primary user to verbally communicate and interact with the system 10 from a remote location. The voice input means 802 may be activated with an audio signal is present and deactivated when no audio signal is present. Any known compression/decompression (CODEC) means known in the art may be used by the primary user to communicate one or more source and user inputs to the system 10 via a transceiver. The fob module 24 may communicate with the system 10 using wireless technology including a transmitter and receiver, or any other suitable wireless methodologies as is known in the art.

Referring to the embodiment of the fob module shown in FIG. 9, the fob module 24 includes a display screen 804 which may provide one or more outputs to the primary user, such as reminders, weather information and an itinerary, for example. It should be appreciated that the fob module 24 may also include many of the modules comprising the central processing module 16, such as a schedule module and reminder module. Moreover, the fob module 24 may be provided with one or more source modules to enable the gathering and input of medical data, such as body temperature, heart rate and blood pressure, to the system 10. In addition, the fob module 24 may be adapted to interconnect with various telemedicine components, such a respiratory devices or electroencncephalogam (EEG) devices, and to communicate the inputs from these telemedicine components to the system 10 and/or secondary users.

Referring to the embodiment of the fob module shown in FIG. 10, the fob module 24 may provide the dual function of a walking aid for an elderly primary user and a portable communication device for interacting and communicating with the system 10. One or more source modules may be provided within the handle portion 806 of the fob module to enable the system 10 to monitor the condition and well being of the primary user.

Each of the fob modules 24 shown in FIGS. 9, 10 and 11 may be provided with a global positioning (GPS) means which functions as the terminal end of a telecommunication link, such as a cell phone. By this design, the system 10 will be to monitor and track the whereabouts of the primary user, and particularly a primary user suffering from mental ailments, such as Alzheimer's syndrome. For example, when the location of the primary user is sought by a secondary user, the system 10 may generate and communicate one or more outputs to the GPS within the fob module 24. The system 10 may also generate and communicate one or more outputs to the primary user instructing them to remain at their present location until one or more secondary users are dispatched.

In further embodiments of the present invention, a network of systems 10 may be provided whereby each system 10 within the network may communicate with other systems within the network. The network of system 10 may be adapted to enable each of the systems to anonymously communicate and share various the one or more outputs, contextual patterns, source inputs, user inputs and/or other data to maximize the monitoring and managing capabilities of the system 10 for each of the primary users. A network of systems 10 could also be used to create “interest groups” to enable the primary users to communicate and interact with each other. Each of the fob modules 24 may be provided with a unique identification means, such as serial number or an algorithm, to ensure the security and confidentially of the data communicated to and from the fob module 24 and the system 10

The present invention has been described with regard to specific embodiments. However, it will be obvious to persons skilled in the art that a number of variants and modifications can be made without departing from the scope and spirit of the invention described herein.

1. A personal management system for monitoring and interacting with a primary user located within a residence, the system comprising:
(a) one or more source modules provided throughout the residence, the one or more source modules being adapted to gather one or more source inputs concerning the conditions within the residence;
(b) one or more input modules provided to the primary user and throughout the residence, the one or more input modules being adapted to receive one or more user inputs from the primary user, wherein the one or more user inputs are requests for one or more outputs received from the primary user;
(c) a central processing module communicating with the one or more source modules and the one or more inputs modules, wherein the central processing module is programmed to analyze the one or more source inputs and the one or more user inputs, and wherein the central processing module is further programmed to dynamically generate one or more outputs based on the conditions within the residence and the requests from the primary user; and
(d) one or more output modules provided throughout the residence and being adapted to perform and communicate the one or more outputs for the primary user.

2. The personal management system as claimed in claim 1, wherein the central processing module being adapted to communicate the one or more source inputs to a secondary user situated at a remote location.

3. The personal management system as claimed in claim 1, wherein the central processing module being adapted to communicate the one or more user inputs to a secondary user situated at a remote location.

4. The personal management system as claimed in claim 1, wherein the central processing module being adapted to communicate the one or more outputs to a secondary use situated at a remote location.

5. The personal management system as claimed in claim 1, further including one or more cognitive databases, each of the one or more cognitive databases being adapted to store and load the one or more source inputs, the one or more user inputs and the one or more outputs.

6. The personal management system as claimed in claim 1, wherein the central processing module being adapted to retrieve one or more historical outputs from a database that were previously generated by the system concerning the one or more source inputs and the one or more user inputs, and wherein the central processing module being adapted to dynamically generate one or more outputs in response to the one or more source inputs and the one or more user inputs based on the one or more historical outputs.

7. The personal management system as claimed in claim 1, wherein the central processing module further including a speech generator for interactively communicating with the primary user, and wherein the speech generator being adapted to communicate the one or more outputs to the primary user in the form of synthesized speech.

8. The personal management system as claimed in claim 1, wherein the central processing further including an inference engine adapted to analyze and interpret the one or more outputs based on the contextual patterns contained in the one or more source inputs and the one or more user inputs.

9. The personal management system as claimed in claim 1, wherein the one or more output modules provided throughout the residence include addressable speakers and being adapted to perform and communicate the one or more outputs for the primary user.

10. The personal management system as claimed in claim 1, wherein the one or more source inputs contain information concerning the condition of the primary user and the residence.

11. A method for providing personal management monitoring and interaction with a primary user located within a residence, the method comprising:
(a) receiving one or more source inputs concerning the conditions within the residence;
(b) receiving one or more user inputs from the primary user;
(c) analyzing and interpreting the one or more source inputs and the one or more user inputs;
(d) retrieving one or more historical outputs from a database that were previously communicated to the primary user generally concerning the one or more source inputs and the one or more user inputs; and
(e) dynamically generating one or more outputs concerning the one or more source inputs and the one or more user inputs.

12. The method for providing personal management monitoring and interaction as claimed in claim 11, further comprising the additional step of performing and communicating the one or more outputs for the primary user.

13. The method of providing personal management monitoring and interaction as claimed in claim 11, wherein the one or more user inputs are requests for one or more outputs received from the primary user.

14. The method for providing personal management monitoring and interaction as claimed in claim 11, wherein the steps (a), (b), (c), (d) and (e) are performed iteratively.

15. The method for providing personal management monitoring and interaction as claimed in claim 11, further comprising the additional step of generating one or more outputs for the primary user based upon the occurrence of one or more scheduled triggering events.

16. The method for providing personal management monitoring and interaction as claimed in claim 11, wherein the one or more user inputs are verbally communicated and inputted by the primary user.

17. The method for providing personal management monitoring and interaction as claimed in claim 11, wherein the one or more outputs are verbally communicated to the primary user.

18. The method for providing personal management monitoring and interaction as claimed in claim 11, wherein the one or more outputs perform functions within the residence for the primary user.

19. The method for providing personal management monitoring and interaction as claimed in claim 11, wherein the one or more outputs are communicated to one or more secondary users, and wherein the one or more outputs providing the one or more secondary users with information concerning the condition of the primary user and the residence.
